(19) United States
(12) Patent Application Publication
(10) Pub. No.: US 2026/0037826 A1
(43) Pub. Date: Feb. 5, 2026

(54) SYSTEM AND METHOD FOR HIERARCHICAL CONSENSUS FEDERATED LEARNING METHOD TOWARDS PRODUCTION FAIRNESS

(71) Applicant: Robert Bosch GmbH, Stuttgart (DE)

(72) Inventors: Zhenzhen LI, Gibsonia, PA (US); Filipe J. CABRITA CONDESSA, Pittsburgh, PA (US); Wan-Yi LIN, Wexford, PA (US); Tobias SCHLAGENHAUF, Albstadt (DE); Chen QIU, Pittsburgh, PA (US); Madan Ravi GANESH, Pittsburgh, PA (US)

(21) Appl. No.: 18/790,267

(22) Filed: Jul. 31, 2024

(51) Int. Cl. G06N 3/098

(52) U.S. Cl. CPC G06N 3/098

(57) ABSTRACT

A method of training neural networks with federated learning that includes sending portions of server-maintained machine learning models to clients, yielding local models in sync with the server; at each client, training a local model with local data, receiving a model parameter including a global-shared encoder and cluster-shared prediction head from the server, utilizing the cluster-shared prediction head for server aggregating models from clients in the respective cluster; at each client, syncing with the server on its locally updated model; at the server, updating the global-shared encoder by aggregating updates of the cross-entropy loss from clients; at the server, updating cluster-shared prediction heads by aggregating updates from clients in each cluster; at the server, sending updated global and cluster-shared model parameters to clients; repeating steps until a threshold is met; outputting a final parameter including a final global-shared encoder and cluster-shared model parameter for each cluster.

### TECHNICAL FIELD

The present disclosure relates to federated learning in machine learning models.

### BACKGROUND

In federated learning, the presence of heterogeneous data often leads to client drift, reduced accuracy, and non-convergence. These issues are widely acknowledged in the field. Moreover, the heterogeneity of the data distributions can also lead to non-homogeneous performances and unfairness among clients in a federated learning system. The fairness for a federated learning system in production should include maintaining the median of clients accuracies in high performance while increasing the lower quantile of clients accuracies so all clients in the system do not have too much performance difference, instead of equality of risk as in previous systems. This may lead to a more evenly accuracy distribution. Such fairness is important for production as the lower quantile of client's accuracies is crucial for production as bad user experiences will lead to corruption of company reputation. Thus, an important problem to be solved in federated learning for production application is to boost such fairness.

### SUMMARY

According to a first embodiment, a method of training neural networks with federated learning includes sending portions of server-maintained machine learning models to clients, yielding local models in sync with the server; at each client, training a local model with local data, receiving a model parameter including a global-shared encoder and cluster-shared prediction head from the server, utilizing the cluster-shared prediction head for server aggregating models from clients in the respective cluster; at each client, syncing with the server on its locally updated model; at the server, updating the global-shared encoder by aggregating updates of the cross-entropy loss from clients; at the server, updating cluster-shared prediction heads by aggregating updates from clients in each cluster; at the server, sending updated global and cluster-shared model parameters to clients; repeating steps until a threshold is met; outputting a final parameter including a final global-shared encoder and cluster-shared model parameter for each cluster.

According to a second embodiment, a system of training neural networks with federated learning includes memory storing instructions and a plurality of processors that, when executing the instructions stored in the memory, collectively perform sending at least portions of a plurality of server-maintained machine learning models from a server to a plurality of clients, yielding a plurality of local machine learning models that are in sync the server with the plurality of clients, at each client, training a local machine learning model with locally-stored data that is stored locally at that respective client, wherein the training at each client includes receiving a model parameter that includes both a global-shared encoder parameter and a respective cluster-shared prediction head from the server to conduct local training at the client, wherein the cluster-shared prediction head is utilized for server aggregating models from clients associated with that respective cluster, at each client, sync with the server on its locally updated model, at the server, updating the global-shared encoder parameter by aggregating updates of a cross-entropy loss from each of the plurality of clients and updating, for each cluster, the cluster-shared prediction head by aggregating the updates from the clients that belong to that respective cluster, sending the plurality of clients both an updated globally-shared model parameter to the plurality of clients and a cluster-shared model parameter to an associated cluster of clients from the plurality of clients and in response to meeting the threshold, outputting a final parameter associated with the model, wherein the final parameter includes a final global-shared encoder parameter and a final cluster-shared model parameter for each respective cluster.

According to a third embodiment, a method of training neural networks with federated learning includes sending at least portions of a plurality of server-maintained machine learning models from a server to a plurality of clients, yielding a plurality of local machine learning models, estimating, at the server, a cluster label for the clients, wherein the estimating utilizes a k-means algorithm on latent features output from each of the clients, at each client, training the plurality of local machine learning models with locally-stored data that is stored locally at that respective client, wherein the training at each client includes receiving a model parameter that includes both a global-shared encoder parameter and a respective cluster-shared prediction head from the server to conduct local training at the client, wherein the cluster-shared prediction head is utilized for clients associated with that respective cluster in response for the cluster label, at the server, updating the global-shared encoder parameter by aggregating updates of a cross-entropy loss from each of the plurality of clients, updating, for each cluster, the cluster-shared prediction head by aggregating the updates from the clients that belong to that respective cluster, sending the plurality of clients both an updated globally-shared model parameter to the plurality of clients and a cluster-shared model parameter to an associated cluster of clients from the plurality of clients and in response to meeting a threshold, outputting a final parameter associated with the model, wherein the final parameter includes a final global-shared encoder parameter and a final cluster-shared model parameter for each respective cluster.

### BRIEF DESCRIPTION OF THE DRAWINGS

FIG. 1 shows a system for training a neural network, according to an embodiment.

FIG. 2 shows a computer-implemented method for training and utilizing a neural network, according to an embodiment.

FIG. 3 shows an example diagram or layout of a federated learning system, according to an embodiment.

FIG. 4 shows a schematic of a deep neural network with nodes in an input layer, multiple hidden layers, and an output layer, according to an embodiment.

FIG. 5 depicts a schematic diagram of an interaction between a computer-controlled machine and a control system, according to an embodiment.

FIG. 6 depicts a schematic diagram of the control system of FIG. 5 configured to control a vehicle, which may be a partially autonomous vehicle, a fully autonomous vehicle, a partially autonomous robot, or a fully autonomous robot, according to an embodiment.

FIG. 7 depicts a schematic diagram of the control system of FIG. 5 configured to control a manufacturing machine, such as a punch cutter, a cutter or a gun drill, of a manufacturing system, such as part of a production line.

FIG. 8 depicts a schematic diagram of the control system of FIG. 5 configured to control a power tool, such as a power drill or driver, that has an at least partially autonomous mode.

FIG. 9 depicts a schematic diagram of the control system of FIG. 5 configured to control an automated personal assistant.

FIG. 10 depicts a schematic diagram of the control system of FIG. 5 configured to control a monitoring system, such as a control access system or a surveillance system.

FIG. 11 depicts a schematic diagram of the control system of FIG. 5 configured to control an imaging system, for example an MRI apparatus, x-ray imaging apparatus or ultrasonic apparatus.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

A distributed machine learning algorithm may allow clients to collaboratively train a global model while keeping their data locally stored and private. It may work by utilizing a central server that sends the initial global model to clients, clients update the model a few epochs of training on the local data and sending it back, the server then aggregate their updates into a global model, and repeating this process until convergence is achieved. FedAvg (one federated learning system) enables updating the global model by averaging the knowledge from multiple clients. FedAvg may only contains one global model as the single consensus knowledge to help with the local training. However, in manufacturing and production, companies have internal information about the product types and working conditions for different machines in the federated learning system, and such information could be used to form clusters and such cluster information can be further used to construct cluster-wise knowledge consensus and help with local training.

More specifically, the system and method may assume that they are provided with externally learnt or given cluster information regarding participated clients in a federated learning system. Then, different from FedAvg, the system may not only aggregate global model as global knowledge consensus, but also aggregated clients models within each cluster and get cluster-wise knowledge consensus. Further, both global model and the corresponding cluster models are sent to each clients, and clients use such global and cluster information along with local datasets to supervise its local training. This involves executing local epoch training while employing hierarchical consensus models as a regularization.

The system may define the p-fairness as a metric for production fairness that considers the lower quantile accuracy of a FL system as well as median accuracy. Thus, the system may use harmonic mean to define the balance between the two as follows:

$$p - Fairness = \frac{2 \cdot {Acc}_{lower quantile} \cdot {Acc}_{median}}{{Acc}_{lower quantile} + {Acc}_{median}} \qquad ( Equation 1 )$$

where the “Accuracy” is the set of accuracies of a federated learning algorithm and the lower-quantile represents any bottom quantile from 0% to 50%.

This metric is also the first fairness metric that consider both overall (median) system performance and the lowest-quantile system performance, targeting manufacturing applications.

In one example, gFed is a personalized FL algorithms taking production fairness and user experiences into consideration. The idea of the approach is to make use of hierarchical knowledge consensus in a federated learning system. Specifically, the system may consider two levels of knowledge consensus: globally shared information and cluster shared information, and split the model parameterized by neural networks to a global-shared encoder and a cluster-shared prediction head, as shown below. Such encoder-head split of the model can be tailored on a per-application basis. The global-shared encoder θ_{global} is updated by aggregating the updates among all clients to capture the global knowledge consensus, while the cluster-shared prediction head θ_{cluster,l}_{ᵢ} is updated by clients belonging to the cluster lᵢ only. Assuming we have N clients and K clusters, with client i being assigned cluster-label lᵢ∈[K] where the model is parameterized by θᵢ. The system and method may initialize the model parameters, with the clusters as described in the flow chart below and system initialization algorithm.

As in many industrial application and manufacturing, there are cases that the cluster labels can be learned externally or given. Thus, we provide two kinds of scenarios that consist of fixed cluster labels (externally learned or given) and estimated cluster labels (through K-means on latent features from a common feature extractor). The gFed is related to an embodiment with cluster labels externally provided, while the gFed-est is for the embodiment that utilizes an estimated cluster label utilizing K-means on latent features from a common feature extractor.

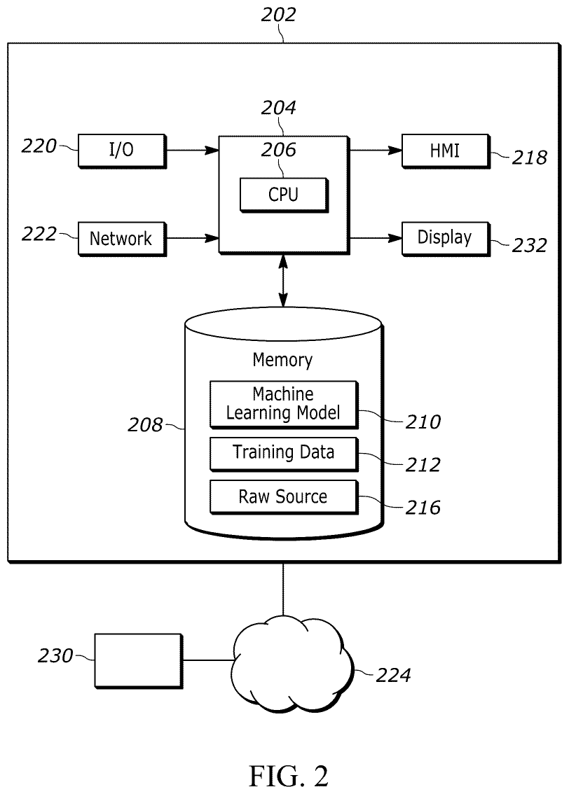

The two embodiments, gFed and gFed-est, are personalized FL algorithms taking production fairness and user experiences into consideration. The idea of the approaches is to make use of hierarchical knowledge consensus in a federated learning system. Specifically, we consider two levels of knowledge consensus: globally shared information and cluster shared information, and split the model parameterized by neural networks to a global-shared encoder and a cluster-shared prediction head as shown in FIG. 2. The split of backbones can be tailored on a per-application basis. The global-shared encoder θ_{global} is updated by aggregating the updates among all clients to capture the global knowledge consensus, while the cluster-shared prediction head θ_{cluster,l}_{ᵢ} is updated by clients belonging to the cluster lᵢ only. Assuming we have N clients and K clusters, with client i being assigned cluster-label lᵢ∈[K] where the model is parameterized by θᵢ. We initialize the model parameters, the clusters as described in Algorithm 2 below. The approach is an iterative algorithm and it repeats steps (i)-(iii) until convergence or reaching the maximum number for rounds R. The algorithm flow chart is provided in Algorithm 1 below.

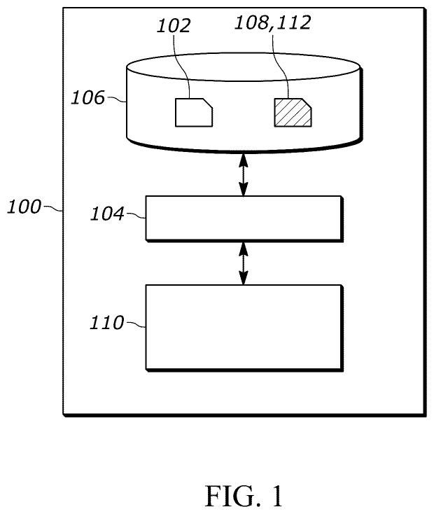

The federated learning system can utilize machine learning training and processes shown in FIGS. 1-2. FIG. 1 shows a system 100 for training a neural network, e.g. a deep neural network. The neural network being trained may reside on the server or the client. In other words, both the server and the client may utilize the teachings of FIG. 1. The system 100 may comprise an input interface for accessing training data 102 for the neural network. For example, as illustrated in FIG. 1, the input interface may be constituted by a data storage interface 104 which may access the training data 102 from a data storage 106. For example, the data storage interface 104 may be a memory interface or a persistent storage interface, e.g., a hard disk or an SSD interface, but also a personal, local or wide area network interface such as a Bluetooth, Zigbee or Wi-Fi interface or an Ethernet or Fiberoptic interface. The data storage 106 may be an internal data storage of the system 100, such as a hard drive or SSD, but also an external data storage, e.g., a network-accessible data storage.

In some embodiments, the data storage 106 may further comprise a data representation 108 of an untrained version of the neural network which may be accessed by the system 100 from the data storage 106. It will be appreciated, however, that the training data 102 and the data representation 108 of the untrained neural network may also each be accessed from a different data storage, e.g., via a different subsystem of the data storage interface 104. Each subsystem may be of a type as is described above for the data storage interface 104. In other embodiments, the data representation 108 of the untrained neural network may be internally generated by the system 100 on the basis of design parameters for the neural network, and therefore may not explicitly be stored on the data storage 106. The system 100 may further comprise a processor subsystem 110 which may be configured to, during operation of the system 100, provide an iterative function as a substitute for a stack of layers of the neural network to be trained. Here, respective layers of the stack of layers being substituted may have mutually shared weights and may receive as input an output of a previous layer, or for a first layer of the stack of layers, an initial activation, and a part of the input of the stack of layers. The processor subsystem 110 may be further configured to iteratively train the neural network using the training data 102. Here, an iteration of the training by the processor subsystem 110 may comprise a forward propagation part and a backward propagation part. The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network. The system 100 may further comprise an output interface for outputting a data representation 112 of the trained neural network; this data may also be referred to as trained model data 112. For example, as also illustrated in FIG. 1, the output interface may be constituted by the data storage interface 104, with said interface being in these embodiments an input/output (‘IO’) interface, via which the trained model data 112 may be stored in the data storage 106. For example, the data representation 108 defining the ‘untrained’ neural network may during or after the training be replaced, at least in part by the data representation 112 of the trained neural network, in that the parameters of the neural network, such as weights, hyperparameters and other types of parameters of neural networks, may be adapted to reflect the training on the training data 102. This is also illustrated in FIG. 1 by the reference numerals 108, 112 referring to the same data record on the data storage 106. In other embodiments, the data representation 112 may be stored separately from the data representation 108 defining the ‘untrained’ neural network. In some embodiments, the output interface may be separate from the data storage interface 104, but may in general be of a type as described above for the data storage interface 104.

The structure of the system 100 is one example of a system that may be utilized to train the models utilized by the federated learning system described herein. Additional structure for operating and training these machine-learning models is shown in FIG. 2.

FIG. 2 depicts a federated learning system 200 configured to execute and train the machine-learning models described herein, for example the neural networks or deep neural networks. The system 200 can be implemented to perform the federated learning processes described herein. The system 200 may include at least one computing system 202. The computing system 202 may be part of or executed by a client device, such as a smart phone, Internet of Things device, medical device, or other device such as those described herein with reference to FIGS. 6-11 described below. By way of example and not by way of limitation, computing system 202 may be an embedded computer system, a system-on-chip (SoC), a single-board computer system (SBC) (such as, for example, a computer-on-module (COM) or system-on-module (SOM)), a laptop computer, a personal device such as a smart phone or tablet, a mesh of personal devices, or a combination of these. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction set such as one of the x86, ARM, Power, or MIPS instruction set families. During operation, the CPU 206 may execute stored program instructions that are retrieved from the memory unit 208. The stored program instructions may include software that controls operation of the CPU 206 to perform the operation described herein. In some examples, the processor 204 may be a system-on-chip (SoC) that integrates functionality of the CPU 206, the memory unit 208, a network interface, and input/output interfaces into a single integrated device. The computing system 202 may implement an operating system for managing various aspects of the operation. While one processor 204, one CPU 206, and one memory 208 is shown in FIG. 2, of course more than one of each can be utilized in an overall system.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine-learning model 210 or algorithm, a training dataset 212 for the machine-learning model 210, raw source dataset 216.

The computing system 202 may include a network interface device 222 that is configured to provide communication with external systems and devices. For example, the network interface device 222 may include a wired and/or wireless Ethernet interface as defined by Institute of Electrical and Electronics Engineers (IEEE) 802.11 family of standards. The network interface device 222 may include a cellular communication interface for communicating with a cellular network (e.g., 3G, 4G, 5G). The network interface device 222 may be further configured to provide a communication interface to an external network 224 or cloud, enabling the device executing the computing system 202 (e.g., client device) to communicate with the server 230.

The external network 224 may be referred to as the world-wide web or the Internet. The external network 224 may establish a standard communication protocol between computing devices. The external network 224 may allow information and data to be easily exchanged between computing devices and networks.

One or more servers 230 may be in communication with the external network 224. Each server may include a computing system, such as computing system 202, so that the server 230 is configured to perform machine learning and train neural networks. Of course, in keeping with the spirit of this disclosure, certain personal or sensitive raw source data 216 that originate from a particular client device may not transfer to the server 230, and thus the raw source data at the server may be non-existent or may be completely independent of the raw source data on a computing system 202 of a client device. During operation of the federated learning system, as will be described below, the computing system 202 associated with a client device may exchange parts of the training data 212 but not the raw source data 216 or any personal data so as to preserve privacy for any sensitive personal data residing on the client device. The server 230 can then access this information via connection to the network 224, and update its stored models on the server-side.

The computing system 202 may include an input/output (I/O) interface 220 that may be configured to provide digital and/or analog inputs and outputs. The I/O interface 220 is used to transfer information between internal storage and external input and/or output devices (e.g., HMI devices). The I/O 220 interface can includes associated circuitry or BUS networks to transfer information to or between the processor(s) and storage. For example, the I/O interface 220 can include digital I/O logic lines which can be read or set by the processor(s), handshake lines to supervise data transfer via the I/O lines, timing and counting facilities, and other structure known to provide such functions. Examples of input devices include a keyboard, mouse, camera, sensors, etc. Examples of output devices include monitors, screens, printers, speakers, etc. The I/O interface 220 may include additional serial interfaces for communicating with external devices (e.g., Universal Serial Bus (USB) interface). The I/O interface 220 can be referred to as an input interface (in that it transfers data from an external input, such as a sensor), or an output interface (in that it transfers data to an external output, such as a display).

The computing system 202 may include a human-machine interface (HMI) device 218 that may include any device that enables the system 200 to receive control input. Examples of input devices may include human interface inputs such as a keyboard, mouse, touchscreen, voice input devices (e.g., microphone), and other similar devices. The computing system 202 may include a display device 232. The computing system 202 may include hardware and software for outputting graphics and text information to the display device 232. The display device 232 may include an electronic display screen, projector, printer, speaker, or other suitable device for displaying information to a user or operator. The computing system 202 may be further configured to allow interaction with remote HMI and remote display devices via the network interface device 222.

The system 200 may be implemented using one or multiple computing systems. While the example depicts a single computing system 202 that implements all of the described features, it is intended that various features and functions may be separated and implemented by multiple computing units in communication with one another. In particular, a client device may implement the computing system 202, and the server 230 may also include its own computing system 202. The particular system architecture selected may depend on a variety of factors.

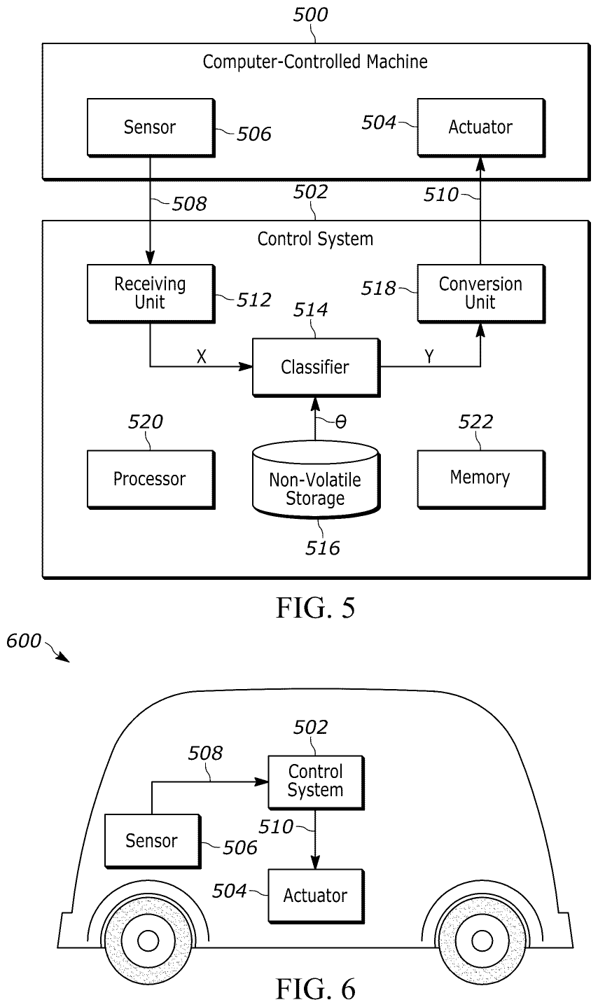

The federated learning system 200 may implement a machine-learning algorithm 210 that is configured to analyze the raw source dataset 216. The raw source dataset 216 may include raw or unprocessed sensor data that may be representative of an input dataset for a machine-learning system. The raw source dataset 216 may include video, video segments, images, text-based information, audio or human speech, time series data (e.g., a pressure sensor signal over time), and raw or partially processed sensor data (e.g., radar map of objects). The raw source dataset 216 may include sensitive or personal data with heightened security necessities, and therefore the raw source dataset 216 may not transfer from the client device to the server 230. Several different examples of inputs are shown and described with reference to FIGS. 5-11. In some examples, the machine-learning algorithm 210 may be a neural network algorithm (e.g., deep neural network) that is designed to perform a predetermined function. For example, the neural network algorithm may be configured in automotive applications to identify street signs or pedestrians in images. The neural network algorithm may be configured to auto-correct text or speech based on the context of the words from the individual.

The computing system 202 may store a training dataset 212 for the machine-learning algorithm 210. The training dataset 212 may represent a set of previously constructed data for training the machine-learning algorithm 210. The training dataset 212 may be used by the machine-learning algorithm 210 to learn weighting factors associated with a neural network algorithm. The training dataset 212 may include a set of source data that has corresponding outcomes or results that the machine-learning algorithm 210 tries to duplicate via the learning process.

The machine-learning algorithm 210 may be operated in a learning mode using the training dataset 212 as input. The machine-learning algorithm 210 may be executed over a number of iterations using the data from the training dataset 212. With each iteration, the machine-learning algorithm 210 may update internal weighting factors based on the achieved results. For example, the machine-learning algorithm 210 can compare output results (e.g., a reconstructed or supplemented image, in the case where image data is the input) with those included in the training dataset 212. Since the training dataset 212 includes the expected results, the machine-learning algorithm 210 can determine when performance is acceptable. After the machine-learning algorithm 210 achieves a predetermined performance level (e.g., 100% agreement with the outcomes associated with the training dataset 212), or convergence, the machine-learning algorithm 210 may be executed using data that is not in the training dataset 212. It should be understood that in this disclosure, “convergence” can mean a set (e.g., predetermined) number of iterations have occurred, or that the residual is sufficiently small (e.g., the change in the approximate probability over iterations is changing by less than a threshold), or other convergence conditions. The trained machine-learning algorithm 210 may be applied to new datasets to generate annotated data.

The machine-learning algorithm 210 may be configured to identify a particular feature in the raw source data 216. The raw source data 216 may include a plurality of instances or input dataset for which supplementation results are desired. For example, the machine-learning algorithm 210 may be configured to identify the presence of a person in video images and annotate the occurrences. The machine-learning algorithm 210 may be programmed to process the raw source data 216 to identify the presence of the particular features. The machine-learning algorithm 210 may be configured to identify a feature in the raw source data 216 as a predetermined feature (e.g., a particular word, in the case where text or spoken words is the input). The raw source data 216 may be derived from a variety of sources. For example, the raw source data 216 may be actual input data collected by a machine-learning system. The raw source data 216 may be machine generated for testing the system. As an example, the raw source data 216 may include raw images or video from a camera, spoken words from a microphone, or typed or written words from a keyboard or touch screen, or the like.

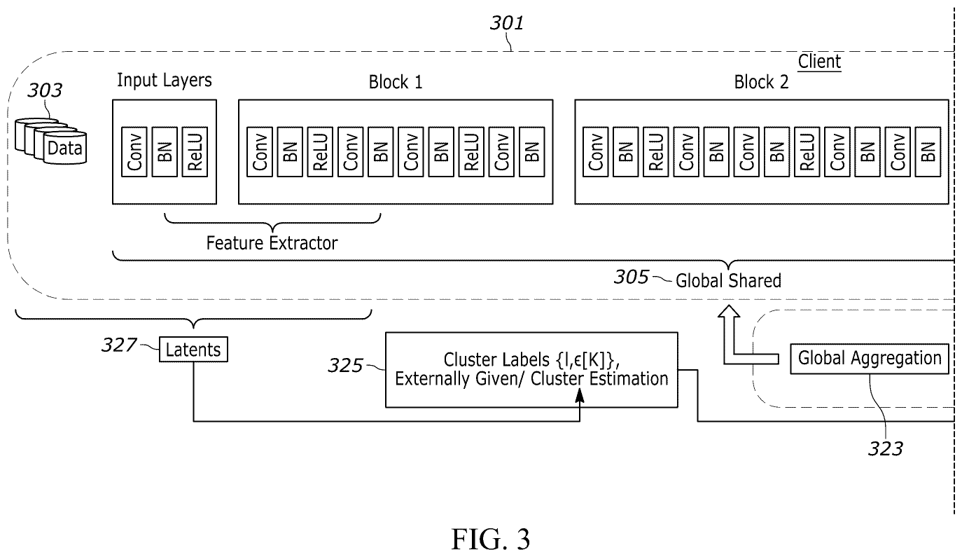

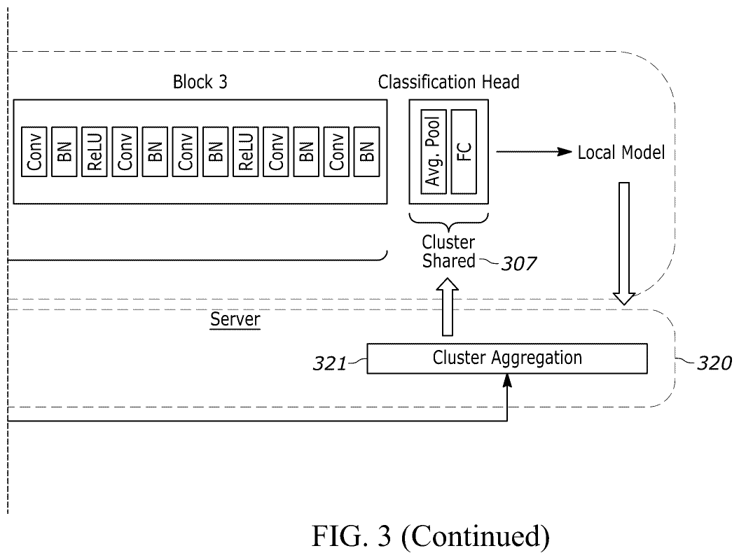

FIG. 3 shows an example diagram or layout of a federated learning system, according to an embodiment. Such an approach is an iterative algorithm and it repeats steps (i)-(ii) until convergence or reaching the maximum number for rounds R. The algorithm flow chart is provided in Algorithm 1, below.

In one embodiment, the system may have local updates at the client. Assuming a set of clients are participating the learning at the r-th round, denoted with Sᵣ, each participating client i with i∈Sᵣ receives the model θᵢ including a global-shared encoder θ_{i,global} and a cluster-shared prediction head θ_{i,cluster} from server and conduct local training on the local-stored data Dᵢ by using its own optimizer to minimize

$${L}_{i} ( {θ}_{i} ) = L ( {θ}_{i} , {D}_{i} ) + {λ}_{1} \cdot dist ( {θ}_{i , global} , {θ}_{global}^{( r - 1 )} ) + {λ}_{2} \cdot dist ( {θ}_{i , cluster} , {θ}_{cluster , i}^{( r - 1 )} ) \qquad ( Equation 2 )$$

where the term L(θᵢ, Dᵢ) is the cross entropy loss, and dist(·) is ∥·∥₂².

(ii) Server-end aggregation. The global-shared encoder

$${θ}_{global}^{( r )}$$

is updated by aggregating the updates from all available clients as

$${θ}_{global}^{( r )} = {\sum }_{i ∈ {S}_{r}} \frac{\vert {D}_{i} \vert}{{M}_{r}} \cdot {θ}_{i , global}^{( r )} with {M}_{r} = {\sum }_{i ∈ {S}_{r}} \vert {D}_{i} \vert \qquad ( Equation 3 )$$

The cluster-shared prediction head

$${θ}_{cluster , k}^{( r )}$$

is updated by aggregating the updates from the clients belonging to the cluster k:

$${θ}_{cluster , k}^{( r )} = {\sum }_{i ∈ {S}_{r} : {l}_{i} = k} \frac{\vert {D}_{i} \vert}{{M}_{k}} \cdot {θ}_{i , cluster}^{( r )} , \qquad ( Equation 4 )$$

$$with$$

$${M}_{k} = {\sum }_{i ∈ {S}_{r} : {l}_{i} = k} \vert {D}_{i} \vert for all k ∈ [ K ] .$$

The server may communicate with clients and send both of updated globally shared model

$${θ}_{global}^{( r )}$$

and cluster shared model

$${θ}_{cluster , k}^{( r )}$$

with k∈[K]) to corresponding clients.

After the models converge and training has finished, the system and method may evaluate each clients' performance on the balanced public dataset, and compute p-Fairness for the whole FL system. The system may be validated on public dataset CIFAR10, the proposed method has much higher p-Fairness compared to prior art.

FIG. 3 is an overview of a flowchart for a gFed system. The client 301 may be a smart phone, tablet, laptop computer, desktop computer, Internet of Things (IOT) device, edge device, medical device, security system, autonomous vehicle, smart meter and grid device, industrial machine, power tool, etc. The client 301 may include input data 303, such as images, videos, pictures, radar data, sonar data, sound data, etc. The client 301 may include a portion of the model that is global shared 305 and cluster shared 307. In one example, the global shared 305 portion may be the input layers, block 1, and bock 2, and block 3. Continuing such an example, the classification head may be the cluster shared 307.

The client 301 may be in communication with the server 320. The server 320 may include cluster aggregation 321 and global aggregation 323. Upon the server 321 aggregating the cluster-shared parameter and updating the cluster-shared parameter, the server will send the cluster-shared parameter 307 to the corresponding to the corresponding clients of that cluster. For example, if a group of 10 clients are within that cluster, each cluster will receive the cluster-shared parameter.

The cluster labels 325 may be utilized in the system. Cluster labels may refer to the labels or target values associated with the data samples within a specific cluster of clients. These cluster labels are used during the training process to evaluate the performance of the models trained within each cluster and to compute the loss function, which guides the model optimization. The cluster labels may be utilized for cluster formation, as the clients may be grouped into clusters based on certain criteria, such as geographical proximity, similarity in data distributions, or other relevant factors.

Within each cluster, the clients train their local models using their private data, which includes both input features (e.g., images, text) and corresponding cluster labels (e.g., class labels for classification tasks, target values for regression tasks). After training their local models, clients use a portion of their data (usually referred to as the validation set) to evaluate the model's performance. This evaluation involves comparing the model's predictions with the true cluster labels. The loss function, such as cross-entropy loss for classification tasks or mean squared error for regression tasks, is computed based on these comparisons. The local models' parameters or gradients, along with the computed losses, are then aggregated at the central server to update the global model. The aggregation process considers the contributions of each cluster based on factors like the number of clients or their computing capabilities.

In federated learning, cluster labels are typically kept locally on clients and are not shared directly with the central server. Instead, only model updates (parameters or gradients) and aggregated loss values are transmitted during the federated learning process, ensuring data privacy. Cluster labels allow for the evaluation of model performance within each cluster, enabling clients to assess the effectiveness of their local models in relation to the specific data distributions present in their cluster. By utilizing cluster labels for local model training and evaluation, federated learning enables distributed model training across multiple clusters of clients while preserving data privacy and security.

Overall, cluster labels may be used in federated learning by facilitating local model training, performance evaluation, and loss computation within individual clusters of clients, contributing to the collaborative optimization of a global model across decentralized data sources.

The latents 327 may be utilized for creating the cluster labels. For the embodiment that dynamically creates labels, the clusters are formed by running k-means on the intermediate latents 327, that is, the input samples passed through a common feature extractor. By conducting clustering on the intermediate latents instead of the raw input samples may protect the privacy of the clients. Further, the latent features can represent the underlying heterogencity structure in original data distribution. Specifically, an approximated isometric map can preserve separable structure in the data. Shallow neural networks (such as the common feature extractor) satisfy the isometry property. As such, the common feature extractor can preserve the structure of the heterogeneity of original datasets, which exemplifies the illustrative clustering approach.

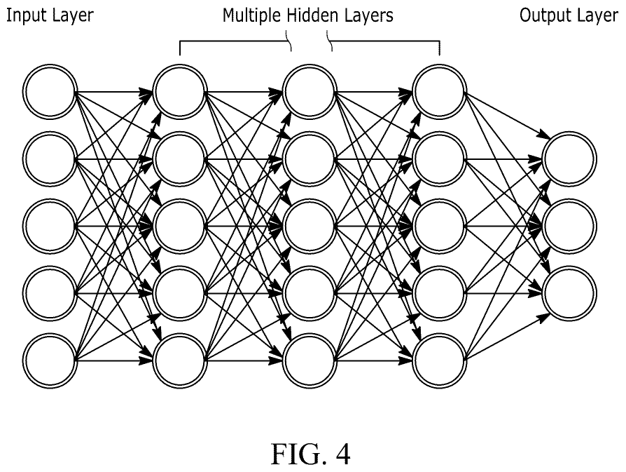

The neural networks trained and executed at either the server or client devices in the client pool can be exemplified by the illustration shown in FIG. 4. FIG. 4 illustrates an embodiment of a model subject to the training by either the server or client. As discussed above, the federated learning system may include machine learning models such as neural network (e.g., and in some cases, while not required, a deep neural network) based models. The model can include an input layer (having a plurality of input nodes) and an output layer (having a plurality of output nodes). In some examples, the model may include a plurality of hidden layers. The nodes of the input layer, output layer, and hidden layers may be coupled to nodes of subsequent or previous layers. And each of the nodes of the output layer may execute an activation function—e.g., a function that contributes to whether the respective nodes should be activated to provide an output of the model. The quantities of nodes shown in the input, hidden, and output layers are merely exemplary and any suitable quantities may be used.

As shown in the algorithm, the system and method may utilize two distinct embodiments, one with externally given cluster labels and the other with dynamically learned cluster labels. For the embodiment with dynamically learned cluster labels, the clusters are formed by running k-means on the intermediate latents, that is, the input samples passed through a common feature extractor. By conducting clustering on the intermediate latents instead of the raw input samples may protect the privacy of the clients. Further, the latent features can represent the underlying heterogeneity structure in original data distribution. Specifically, in one embodiment an approximated isometric map can preserve separable structure in the data. Furthermore, shallow neural networks (such as the common feature extractor) satisfy the isometry property. As such, the common feature extractor can preserve the structure of the heterogeneity of original datasets, which justifies our clustering approach.

In one embodiment, consider a group of points x₁, . . . , x_{N}∈ [symbol] with cluster labels {Lᵢ}_{i∈[N]} where each lᵢ∈[K]. For r<R, we say x₁, . . . , x_{N} is (r, R)-separable with respect to cluster labels {Lᵢ}_{i∈[N]} if

$$‖ {x}_{i} - {x}_{j} ‖ \leq r , ∀ i , j ∈ [ N ] where {l}_{i} = {l}_{j} ;$$

$$‖ {x}_{i} - {x}_{j} ‖ \geq R , ∀ i , j ∈ [ N ] where {l}_{i} \neq {l}_{j} ;$$

In case the cluster labels of clients are not given (e.g., from production labels or prior knowledge), the server may configured to estimate the cluster labels of all clients in Sᵣ by performing the K-means algorithm on the intermediate features pro-vided by clients. The details of the clustering is provided in Algorithm 2 below.

Algorithm 2 FL system initialization

input Server and all clients
1: Start initialization
$2 : Randomly initialize the global shared model {θ}_{global}^{( 0 )}$
$3 : Initialized the local models {θ}_{i}^{( 0 )} with the same global initialized shared feature$
$extractor {θ}_{global}^{( 0 )}$
4: Clustering labels denoted as {lᵢ, i ∈ [N]} is given externally or perform
Algorithm 3 to initialize cluster labels {lᵢ, i ∈ [N]}.
$5 : Initialized the centroids of the clusters {C}_{k} = \frac{1}{\vert \{ i : {l}_{i} = k \} \vert} \sum i : {l}_{i} = k {L}_{i} for all k ∈ [ K ]$
6: Initialize cluster-wise subnetwork parameters set
${θ}_{cluster , k}^{( 0 )} = \sum i : {l}_{i} = k \frac{\vert {D}_{i} \vert}{{M}_{k}} {θ}_{i}^{( 0 )} with {M}_{k} \sum i : {l}_{i} = k \vert {D}_{i} \vert for all k ∈ [ K ]$
7: End initialization
$output {θ}_{global}^{( 0 )} , {θ}_{cluster , {k}^{cluster , k}}^{( 0 )} with k ∈ [ k ] , cluster labels \{ {l}_{i ,} i ∈ [ N ] \} .$

With respect to hierarchical knowledge consensus, the illustrative system and method (e.g., gFed), is a personalized federated learning system method that considers hierarchical knowledge consensus. The metric that may be optimal to boost is the fairness for federated learning system in industrial application, improving the lower quantile performances. As some clients may suffer from insufficient or low-quality data, they can suffer from lagging performances, so it is crucial to help these lower-quantile clients. For this purpose, the system may only one globally aggregated model is insufficient as it will not cater to those lower-quantile clients.

In one embodiment, there exists a federated learning system, where each client's dataset Di is sampled from a distribution parameterized by w(i). Then, the system may show that under FedAveraging, an increase in the variance in w(i) leads to an increase in the upper-quantile loss of the clients.

The above proposition shows that as the degree of datawise heterogeneity increases, the performance of the lowerquantile clients worsens which may lead to unfairness. In contrast, the decrease of heterogeneity helps encourage fairness among clients. Thus, by forming the clusters for heterogeneous clients, the illustrative embodiment (gFed) reduces the heterogeneity per cluster, and results in boosted lower quantile performances.

As shown in the algorithm, the approach (gFed) has two embodiments, one with externally given cluster labels and the other with dynamically learned cluster labels. For the second case, the clusters are formed by running k-means on the intermediate latents, that is, the input samples passed through a common feature extractor. Doing clustering on the intermediate latents instead of the raw input samples protects the privacy of the clients.

In one embodiment, consider a group of points x₁, . . . , x_{N}∈ [symbol] with cluster labels {Lᵢ}_{i∈[N]} where each lᵢ∈[K]. For r<R, we say x₁, . . . , x_{N} is (r, R)-separable with respect to cluster labels {Lᵢ}_{i∈[N]} if

$$‖ {x}_{i} - {x}_{j} ‖ \leq r , ∀ i , j ∈ [ N ] where {l}_{i} = {l}_{j} ;$$

$$‖ {x}_{i} - {x}_{j} ‖ \geq R , ∀ i , j ∈ [ N ] where {l}_{i} \neq {l}_{j} ;$$

Algorithm 1 (gFed) may be described as below:

```
input Federated training system parameters: number of clients N, number of
clusters K, max rounds R, number of local epochs E.
  $1 : FL system initialization : Run Algorithm 2 to get {θ}_{global}^{( 0 )} , {θ}_{cluster , k}^{( 0 )} with k ∈$
[K] cluster labels {lᵢ, i ∈ [N]}.
  2: while r ≤ R do
  3: Server-end: sample participating clients, denoted as Sᵣ. Send over
${θ}_{global}^{( r - 1 )} , {θ}_{cluster , {l}_{t}}^{( r - 1 )} to client - i , i ∈ {S}_{r} .$
  4: Clients-end:
  5: for Client i ∈ Sᵣ do
  6: Client-end local model update According to (3),
$use local optimizer to obtain the solution {θ}_{i}^{( r )}$
$and the corresponding subnetwork weights {θ}_{i , global}^{( r )} , {θ}_{i , cluster}^{( r )}$
  7: end for
  8: Server-end:
  9: Aggregation: update globally shared model according
to equation (4), and update cluster-wise shared
model according to equation (5).
10: Cluster updates: If r ≡ 0 mod τ, if cluster label
dynamically learnt, run server-end K-means update
in Algorithm 3 to update the cluster labels {lᵢ, i ∈ [N]}.
$11 : Synchronization : Prepare to send over {θ}_{i , global}^{( r )} , {θ}_{cluster , k}^{( r )} with k ∈ [ K ] , {l}_{i}$
with i ∈ [N] to clients in a new round.
12: end while
```

output Personalized models θᵢ with i∈[N], knowledge consensus models θ_{global}, θ_{cluster,k} with k∈[K] by taking the Rth-round models.

In another example, consider a group of points x₁, . . . , x_{N}∈ [symbol] are (r,R) separable with respect to cluster labels {lᵢ, i∈[N]} for some r<R. Suppose a map f: [symbol] → [symbol] satisfies the following δ-Approximated Isometry Property:

$$( 1 - δ ) ‖ x - {x}^{′} ‖ \leq ‖ f ( x ) - f ( {x}^{′} ) ‖ \leq ( 1 + δ ) ‖ x - {x}^{′} ‖$$

Then, when

$$δ {<}_{R + r}^{R - r} ,$$

the cluster of points{{r(z_{i,k})}k=1, . . . . K_{I}}i=1, . . . n; satisfies the ((1+δ)r, (1−δ) R) separable property.

In one embodiment, Algorithm 3 may be described as a Server-end K-means clustering, as shown below:
input Number of cluster K, number of steps T
1: Fetching: server communication with clients and the latest latents {lᵢ, i∈[N]} from per client as follows.
2: Client-end latents update Fetch randomly sampled local historical data and apply feature extraction map Lᵢ←Tₑ(Dᵢ) with

$${T}_{e} C {θ}_{global}^{( r - 1 )}$$

3: Cluster updates with K-means: Alternatively do for T steps: (1) Update cluster labels for each client: Lᵢ←arg max_{k∈[K]} dist (Lᵢ, C̅ₖ, for i∈[N]; (2) Update centroids, for

$$k ∈ [ K ] , {\overline{C}}_{k} ← \frac{1}{\vert \{ i : {l}_{i} = k \} \vert} \sum i : {l}_{i} = k {L}_{i}$$

output Cluster labels {lᵢ, i∈[N]}.

The machine-learning models described herein can be used in many different applications. As described above, the raw source data that is locally-stored may be image data, sound data, or the like, and thus various applications in which this data is retrieved or used are shown in FIGS. 6-11 as an example. Structure used for training and using the machine-learning models for these applications (and other applications) are exemplified in FIG. 5. FIG. 5 depicts a schematic diagram of an interaction between a computer-controlled machine 500 and a control system 502. Computer-controlled machine 500 includes actuator 504 and sensor 506. Actuator 504 may include one or more actuators and sensor 506 may include one or more sensors. Sensor 506 is configured to sense a condition of computer-controlled machine 500. Sensor 506 may be configured to encode the sensed condition into sensor signals 508 and to transmit sensor signals 508 to control system 502. Non-limiting examples of sensor 506 include video, radar, LiDAR, microphone, ultrasonic and motion sensors. In one embodiment, sensor 506 is an optical sensor configured to sense optical images of an environment proximate to computer-controlled machine 500.

Control system 502 is configured to receive sensor signals 508 from computer-controlled machine 500. As set forth below, control system 502 may be further configured to compute actuator control commands 510 depending on the sensor signals and to transmit actuator control commands 510 to actuator 504 of computer-controlled machine 500.

As shown in FIG. 5, control system 502 includes receiving unit 512. Receiving unit 512 may be configured to receive sensor signals 508 from sensor 506 and to transform sensor signals 508 into input signals x₁. In an alternative embodiment, sensor signals 508 are received directly as input signals x without receiving unit 512. Each input signal x may be a portion of each sensor signal 508. Receiving unit 512 may be configured to process each sensor signal 508 to product each input signal x. Input signal x may include data corresponding to an image recorded by sensor 506.

Control system 502 includes a classifier 514. Classifier 514 may be configured to classify input signals x into one or more labels using a machine-learning algorithm, such as a neural network described above. Classifier 514 is configured to be parametrized by parameters, such as those described above (e.g., parameter θ). Parameters θ may be stored in and provided by non-volatile storage 516. Classifier 514 is configured to determine output signals y from input signals x. Each output signal y includes information that assigns one or more labels to each input signal x. Classifier 514 may transmit output signals y to conversion unit 518. Conversion unit 518 is configured to covert output signals y into actuator control commands 510. Control system 502 is configured to transmit actuator control commands 510 to actuator 504, which is configured to actuate computer-controlled machine 500 in response to actuator control commands 510. In another embodiment, actuator 504 is configured to actuate computer-controlled machine 500 based directly on output signals y.

Upon receipt of actuator control commands 510 by actuator 504, actuator 504 is configured to execute an action corresponding to the related actuator control command 510. Actuator 504 may include a control logic configured to transform actuator control commands 510 into a second actuator control command, which is utilized to control actuator 504. In one or more embodiments, actuator control commands 510 may be utilized to control a display instead of or in addition to an actuator.

In another embodiment, control system 502 includes sensor 506 instead of or in addition to computer-controlled machine 500 including sensor 506. Control system 502 may also include actuator 504 instead of or in addition to computer-controlled machine 500 including actuator 504.

As shown in FIG. 5, control system 502 also includes processor 520 and memory 522. Processor 520 may include one or more processors. Memory 522 may include one or more memory devices. The classifier 514 (e.g., machine-learning algorithms, such as those described above) of one or more embodiments may be implemented by control system 502, which includes non-volatile storage 516, processor 520 and memory 522.

Non-volatile storage 516 may include one or more persistent data storage devices such as a hard drive, optical drive, tape drive, non-volatile solid-state device, cloud storage or any other device capable of persistently storing information. Processor 520 may be any of the processors or processor subsystems described above with reference to FIGS. 1-2, and may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, tensor processing unit, graphics processing unit, ASIC, or any other devices that manipulate signals (analog or digital) based on computer-executable instructions residing in memory 522. Memory 522 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 520 may be configured to read into memory 522 and execute computer-executable instructions residing in non-volatile storage 516 and embodying one or more machine-learning algorithms and/or methodologies of one or more embodiments. Non-volatile storage 516 may include one or more operating systems and applications. Non-volatile storage 516 may store compiled and/or interpreted from computer programs created using a variety of programming languages and/or technologies, including, without limitation, and cither alone or in combination, Java, C, C++, C#, Objective C, Fortran, Pascal, Java Script, Python, Perl, and PL/SQL.

Upon execution by processor 520, the computer-executable instructions of non-volatile storage 516 may cause control system 502 to implement one or more of the machine-learning algorithms and/or methodologies as disclosed herein. Non-volatile storage 516 may also include machine-learning data (including data parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

FIGS. 6-11 illustrate embodiments of environments in which the federated learning systems described herein can be implemented. Each of these embodiments show an embodiment of a client device. Data originating from the sensor 506 in these embodiments may be the raw source data that is used to train a machine learning model onboard the device (client), but not transferred to the server for protection of the data. FIG. 6 depicts a schematic diagram of control system 502 configured to control vehicle 600, which may be an at least partially autonomous vehicle or an at least partially autonomous robot. Vehicle 600 includes actuator 504 and sensor 506. Sensor 506 may include one or more video sensors, cameras, microphone, radar sensors, ultrasonic sensors, LiDAR sensors, and/or position sensors (e.g. GPS). One or more of the one or more specific sensors may be integrated into vehicle 600. Sensor 506 may include a software module configured to, upon execution, determine a state of actuator 504. One non-limiting example of a software module includes a weather information software module configured to determine a present or future state of the weather proximate vehicle 600 or other location.

Classifier 514 of control system 502 of vehicle 600 may be configured to detect objects in the vicinity of vehicle 600 dependent on input signals x. In such an embodiment, output signal y may include information characterizing the vicinity of objects to vehicle 600. Actuator control command 510 may be determined in accordance with this information. The actuator control command 510 may be used to avoid collisions with the detected objects. The raw source data for the federated learning may include the raw images of the vehicle surroundings, however the vehicle's processing of the objects in the surrounding environment might alter weights in the machine learning model used onboard the vehicle; these adjusted weights can then be sent back to the server's models for updating.

In embodiments where vehicle 600 is an at least partially autonomous vehicle, actuator 504 may be embodied in a brake, a propulsion system, an engine, a drivetrain, or a steering of vehicle 600. Actuator control commands 510 may be determined such that actuator 504 is controlled such that vehicle 600 avoids collisions with detected objects. Detected objects may also be classified according to what classifier 514 deems them most likely to be, such as pedestrians or trees. The actuator control commands 510 may be determined depending on the classification. In a scenario where an adversarial attack may occur, the system described above may be further trained to better detect objects or identify a change in lighting conditions or an angle for a sensor or camera on vehicle 600.

In other embodiments where vehicle 600 is an at least partially autonomous robot, vehicle 600 may be a mobile robot that is configured to carry out one or more functions, such as flying, swimming, diving and stepping. The mobile robot may be an at least partially autonomous lawn mower or an at least partially autonomous cleaning robot. In such embodiments, the actuator control command 510 may be determined such that a propulsion unit, steering unit and/or brake unit of the mobile robot may be controlled such that the mobile robot may avoid collisions with identified objects.

In another embodiment, vehicle 600 is an at least partially autonomous robot in the form of a gardening robot. In such embodiment, vehicle 600 may use an optical sensor as sensor 506 to determine a state of plants in an environment proximate vehicle 600. Actuator 504 may be a nozzle configured to spray chemicals. Depending on an identified species and/or an identified state of the plants, actuator control command 510 may be determined to cause actuator 504 to spray the plants with a suitable quantity of suitable chemicals.

Vehicle 600 may be an at least partially autonomous robot in the form of a domestic appliance. Non-limiting examples of domestic appliances include a washing machine, a stove, an oven, a microwave, or a dishwasher. In such a vehicle 600, sensor 506 may be an optical sensor configured to detect a state of an object which is to undergo processing by the household appliance. For example, in the case of the domestic appliance being a washing machine, sensor 506 may detect a state of the laundry inside the washing machine. Actuator control command 510 may be determined based on the detected state of the laundry.

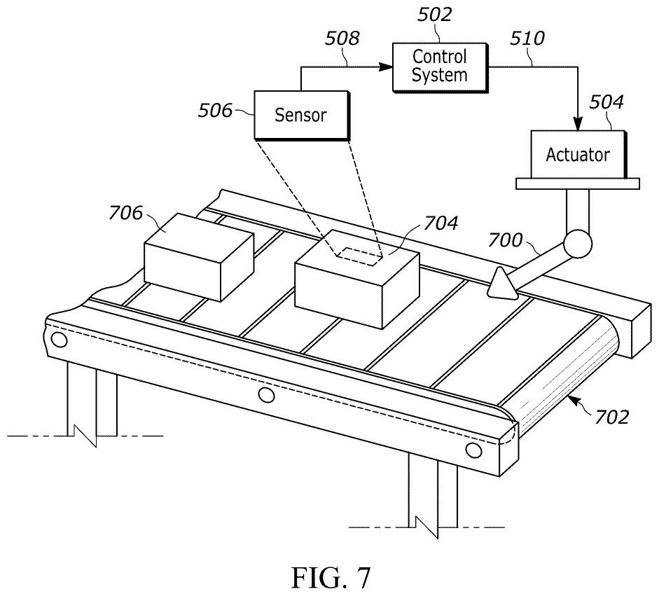

FIG. 7 depicts a schematic diagram of control system 502 configured to control system 700 (e.g., manufacturing machine), such as a punch cutter, a cutter or a gun drill, of manufacturing system 702, such as part of a production line. Control system 502 may be configured to control actuator 504, which is configured to control system 700 (e.g., manufacturing machine).

Sensor 506 of system 700 (e.g., manufacturing machine) may be an optical sensor configured to capture one or more properties of manufactured product 704. Classifier 514 may be configured to determine a state of manufactured product 704 from one or more of the captured properties. Actuator 504 may be configured to control system 700 (e.g., manufacturing machine) depending on the determined state of manufactured product 704 for a subsequent manufacturing step of manufactured product 704. The actuator 504 may be configured to control functions of system 700 (e.g., manufacturing machine) on subsequent manufactured product 706 of system 700 (e.g., manufacturing machine) depending on the determined state of manufactured product 704.

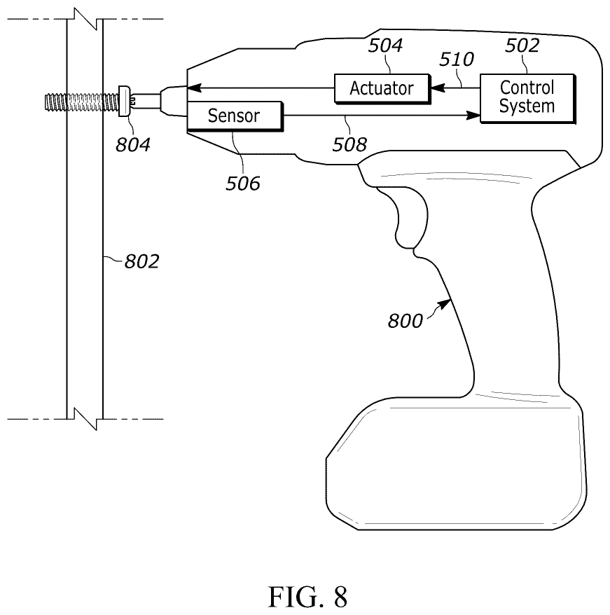

FIG. 8 depicts a schematic diagram of control system 502 configured to control power tool 800, such as a power drill or driver, that has an at least partially autonomous mode. Control system 502 may be configured to control actuator 504, which is configured to control power tool 800.

Sensor 506 of power tool 800 may be an optical sensor configured to capture one or more properties of work surface 802 and/or fastener 804 being driven into work surface 802. Classifier 514 may be configured to determine a state of work surface 802 and/or fastener 804 relative to work surface 802 from one or more of the captured properties. The state may be fastener 804 being flush with work surface 802. The state may alternatively be hardness of work surface 802. Actuator 504 may be configured to control power tool 800 such that the driving function of power tool 800 is adjusted depending on the determined state of fastener 804 relative to work surface 802 or one or more captured properties of work surface 802. For example, actuator 504 may discontinue the driving function if the state of fastener 804 is flush relative to work surface 802. As another non-limiting example, actuator 504 may apply additional or less torque depending on the hardness of work surface 802.

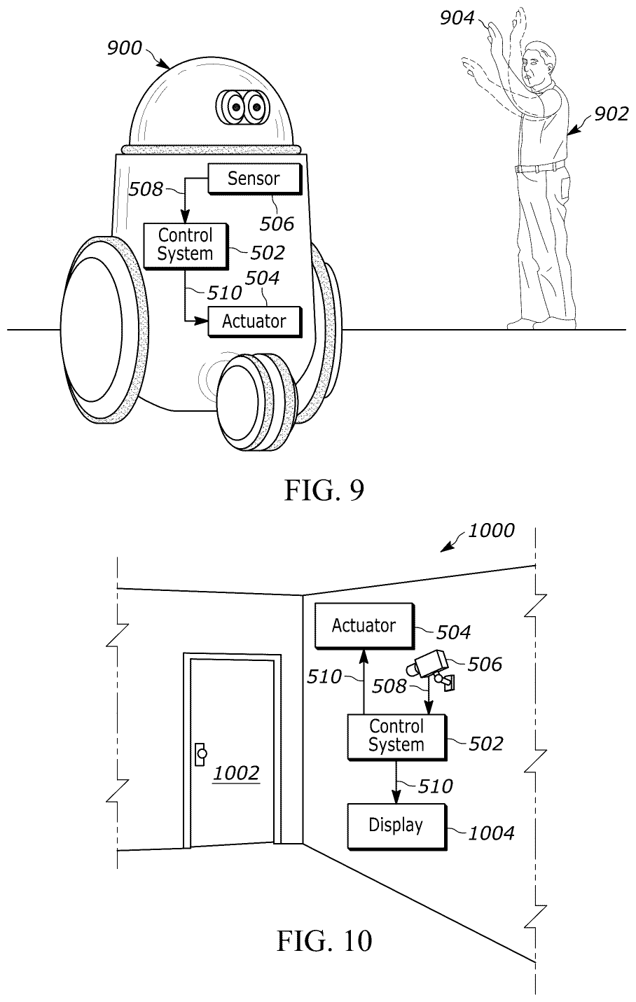

FIG. 9 depicts a schematic diagram of control system 502 configured to control automated personal assistant 900. Control system 502 may be configured to control actuator 504, which is configured to control automated personal assistant 900. Automated personal assistant 900 may be configured to control a domestic appliance, such as a washing machine, a stove, an oven, a microwave or a dishwasher.

Sensor 506 may be an optical sensor and/or an audio sensor. The optical sensor may be configured to receive video images of gestures 904 of user 902. The audio sensor may be configured to receive a voice command of user 902.

Control system 502 of automated personal assistant 900 may be configured to determine actuator control commands 510 configured to control system 502. Control system 502 may be configured to determine actuator control commands 510 in accordance with sensor signals 508 of sensor 506. Automated personal assistant 900 is configured to transmit sensor signals 508 to control system 502. Classifier 514 of control system 502 may be configured to execute a gesture recognition algorithm to identify gesture 904 made by user 902, to determine actuator control commands 510, and to transmit the actuator control commands 510 to actuator 504. Classifier 514 may be configured to retrieve information from non-volatile storage in response to gesture 904 and to output the retrieved information in a form suitable for reception by user 902.

FIG. 10 depicts a schematic diagram of control system 502 configured to control monitoring system 1000. Monitoring system 1000 may be configured to physically control access through door 1002. Sensor 506 may be configured to detect a scene that is relevant in deciding whether access is granted. Sensor 506 may be an optical sensor configured to generate and transmit image and/or video data. Such data may be used by control system 502 to detect a person's face.

Classifier 514 of control system 502 of monitoring system 1000 may be configured to interpret the image and/or video data by matching identities of known people stored in non-volatile storage 516, thereby determining an identity of a person. Classifier 514 may be configured to generate and an actuator control command 510 in response to the interpretation of the image and/or video data. Control system 502 is configured to transmit the actuator control command 510 to actuator 504. In this embodiment, actuator 504 may be configured to lock or unlock door 1002 in response to the actuator control command 510. In other embodiments, a non-physical, logical access control is also possible.

Monitoring system 1000 may also be a surveillance system. In such an embodiment, sensor 506 may be an optical sensor configured to detect a scene that is under surveillance and control system 502 is configured to control display 1004. Classifier 514 is configured to determine a classification of a scene, e.g. whether the scene detected by sensor 506 is suspicious. Control system 502 is configured to transmit an actuator control command 510 to display 1004 in response to the classification. Display 1004 may be configured to adjust the displayed content in response to the actuator control command 510. For instance, display 1004 may highlight an object that is deemed suspicious by classifier 514. Utilizing an embodiment of the system disclosed, the surveillance system may predict objects at certain times in the future showing up.

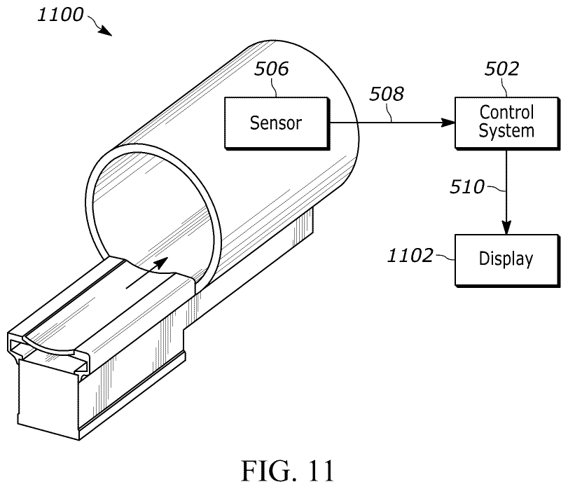

FIG. 11 depicts a schematic diagram of control system 502 configured to control imaging system 1100, for example an MRI apparatus, x-ray imaging apparatus or ultrasonic apparatus. Sensor 506 may, for example, be an imaging sensor. Classifier 514 may be configured to determine a classification of all or part of the sensed image. Classifier 514 may be configured to determine or select an actuator control command 510 in response to the classification obtained by the trained neural network. For example, classifier 514 may interpret a region of a sensed image to be potentially anomalous. In this case, actuator control command 510 may be determined or selected to cause display 1102 to display the imaging and highlighting the potentially anomalous region. The sensed image may be used internal in the hospital environment for training machine learning systems within the hospital (client), however this data is not sent to the server for training of the server's models. Instead, the hospital's adjusted weights that are adjusted based on the sensed images may be sent to the server for adjustment of the weights on the server side.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method of training neural networks with federated learning, the method comprising:
(i) sending at least portions of a plurality of server-maintained machine learning models from a server to a plurality of clients, yielding a plurality of local machine learning models that are in sync the server with the plurality of clients;
(ii) at each client, training a local machine learning model with locally-stored data that is stored locally at that respective client, wherein the training at each client includes receiving a model parameter that includes both a global-shared encoder parameter and a respective cluster-shared prediction head from the server to conduct local training at the client, wherein the cluster-shared prediction head is utilized for server aggregating models from clients associated with that respective cluster;
(iii) at each client, sync with the server on its locally updated model;
(iv) at the server, updating the global-shared encoder parameter by aggregating updates of the cross-entropy loss from each of the plurality of clients;
(v) at the server, updating, for each cluster, the cluster-shared prediction head by aggregating the updates from the clients that belong to that respective cluster;
(vi) at the server, sending the plurality of clients both an updated globally-shared model parameter to the plurality of clients and a cluster-shared model parameter to an associated cluster of clients from the plurality of clients;
(vii) repeating steps (ii) through (vi) until a threshold is met;
(viii) in response to meeting the threshold, outputting a final parameter associated with the model, wherein the final parameter includes a final global-shared encoder parameter and a final cluster-shared model parameter for each respective cluster.

2. The method of claim 1, wherein the threshold is a convergence threshold or a maximum number of rounds.

3. The method of claim 1, wherein the global-shared encoder is updated by aggregating updates from all clients.

4. The method of claim 1, wherein the global-shared encoder is updated by aggregating updates from all clients.

5. The method of claim 1, wherein a number of clients is more than a number of clusters.

6. The method of claim 5, wherein the number of clusters is two or more, and aggregating each client in the two or more clusters is equal to the number of clients.

7. The method of claim 1, wherein the method includes sending final global-shared encoder parameter to all the clients.

8. The method of claim 7, wherein the method includes sending the final cluster-shared model parameter for each respective cluster.

9. The method of claim 1, wherein one or more cluster labels are provided to the clients or server.

10. The method of claim 1, wherein a number of clients is more than a number of clusters.

11. A system of training neural networks with federated learning, the system comprising:
memory storing instructions; and
a plurality of processors that, when executing the instructions stored in the memory, collectively perform:
(i) sending at least portions of a plurality of server-maintained machine learning models from a server to a plurality of clients, yielding a plurality of local machine learning models that are in sync the server with the plurality of clients;
(ii) at each client, training a local machine learning model with locally-stored data that is stored locally at that respective client, wherein the training at each client includes receiving a model parameter that includes both a global-shared encoder parameter and a respective cluster-shared prediction head from the server to conduct local training at the client, wherein the cluster-shared prediction head is utilized for server aggregating models from clients associated with that respective cluster;
(iii) at each client, sync with the server on its locally updated model;
(iv) at the server, updating the global-shared encoder parameter by aggregating updates of a cross-entropy loss from each of the plurality of clients;
(v) at the server, updating, for each cluster, the cluster-shared prediction head by aggregating the updates from the clients that belong to that respective cluster;
(vi) at the server, sending the plurality of clients both an updated globally-shared model parameter to the plurality of clients and a cluster-shared model parameter to an associated cluster of clients from the plurality of clients;
(vii) repeating steps (ii) through (vi) until a threshold is met; and
(viii) in response to meeting the threshold, outputting a final parameter associated with the model, wherein the final parameter includes a final global-shared encoder parameter and a final cluster-shared model parameter for each respective cluster.

12. The system of claim 11, wherein the method includes sending final global-shared encoder parameters to all the clients.

13. The system of claim 11, wherein a number of clients is more than a number of clusters.

14. The system of claim 11, wherein the global-shared encoder is updated by aggregating updates from all clients.

15. The system of claim 11, wherein the global-shared encoder is updated by aggregating updates from all clients.

16. The system of claim 11, wherein the threshold is a convergence threshold or a maximum number of rounds.

17. A method of training neural networks with federated learning, the method comprising:
(i) sending at least portions of a plurality of server-maintained machine learning models from a server to a plurality of clients, yielding a plurality of local machine learning models;
(ii) estimating, at the server, a cluster label for the clients, wherein the estimating utilizes a k-means algorithm on latent features output from each of the clients;
(iii) at each client, training the plurality of local machine learning models with locally-stored data that is stored locally at that respective client, wherein the training at each client includes receiving a model parameter that includes both a global-shared encoder parameter and a respective cluster-shared prediction head from the server to conduct local training at the client, wherein the cluster-shared prediction head is utilized for clients associated with that respective cluster in response for the cluster label;
(iv) at the server, updating the global-shared encoder parameter by aggregating updates of a cross-entropy loss from each of the plurality of clients;
(v) at the server, updating, for each cluster, the cluster-shared prediction head by aggregating the updates from the clients that belong to that respective cluster;
(vi) at the server, sending the plurality of clients both an updated globally-shared model parameter to the plurality of clients and a cluster-shared model parameter to an associated cluster of clients from the plurality of clients;
(vii) repeating steps (iii) through (vi) until a threshold is met; and
(viii) in response to meeting the threshold, outputting a final parameter associated with the model, wherein the final parameter includes a final global-shared encoder parameter and a final cluster-shared model parameter for each respective cluster.

18. The method of claim 17, wherein the method includes sending the final cluster-shared model parameter for each respective cluster.

19. The method of claim 17, wherein one or more cluster labels are provided to the clients or server.

20. The method of claim 17, wherein a number of clients is more than a number of clusters.
